(19) United States
(12) Patent Application Publication
(10) Pub. No.: US 2022/0408794 A1
(43) Pub. Date: Dec. 29, 2022

(54) Roll-Your-Own Cigarette Paper Comprising An Adhesive Strip of Low Grammage

(71) Applicant: Schweitzer-Mauduit International, Inc., Alpharetta, GA (US)

(72) Inventors: Olivier Balcon, Spay (FR); Sebastien Le Panse, Spay (FR); Romuald Leon, Spay (FR); Raoul Herve, Spay (FR)

(21) Appl. No.: 17/780,791

(22) PCT Filed: Nov. 27, 2020
(86) PCT No.: PCT/EP2020/083797

§ 371 Date: May 27, 2022

(30) Foreign Application Priority Data
Nov. 28, 2019 (FR) FR1913406

(51) Int. Cl. A24C 5/00; D21H 19/34; A24D 1/02

(52) U.S. Cl. CPC A24C 5/005; D21H 19/34; A24D 1/022; A24D 1/025

(57) ABSTRACT

The present invention relates to a sheet of roll-your-own cigarette paper comprising an adhesive strip, the grammage of which is less than 8 g/m² and to the process for manufacturing such a paper.

### TECHNICAL FIELD

The invention relates to sheets of paper for roll-your-own (RYO) cigarettes.

### PRIOR ART

The sheets of roll-your-own cigarette paper have a general rectangular shape applied to which is an adhesive strip, the grammage of which is 8-10 g/m². These sheets are sold in the form of a booklet which may comprise around a hundred sheets. To make a cigarette, the user takes a sheet from their booklet, places tobacco on the sheet, then forms the cigarette by moistening the adhesive strip and by overlaying it on the sheet.

Conventionally, the sheets of roll-your-own cigarette paper are manufactured from webs of roll-your-own cigarette paper cut into bobbins of roll-your-own cigarette paper, the width of the bobbins being substantially equal to the width of the sheets. An adhesive strip is then applied on one of the two long edges of the bobbin of roll-your-own cigarette paper in the machine direction, then the bobbin is dried. The dried bobbin is then cut into sheets of roll-your-own cigarette paper.

The roll-your-own cigarette paper has a very low grammage, which may therefore easily tear during the manufacture of the sheet. One of the most problematic steps is the application step of the adhesive strip on the bobbin. Indeed, this step is conventionally carried out using pressurized nozzles which may easily tear the bobbin. This is especially true when the width of the bobbin is less than 10 cm. Furthermore, the adhesive strip is deposited along one of the long edges of the bobbin, a portion of the adhesive strip may therefore be deposited outside of the bobbin so that material is lost and the amount of adhesive strip is not sufficient for a cigarette to be formed.

Because of these problems, conventional processes for the production of the paper for roll-your-own cigarettes have to be regularly stopped. Furthermore, the run speed of the paper in these processes is of the order of 55 m/min, it can therefore be optimized.

For all these reasons, the productivity of these processes is not optimal.

### Technical problem

There is therefore a need for an effective solution for improving the productivity of the process for manufacturing sheets of roll-your-own cigarette paper.

It is thus to the credit of the inventors to have found that it was possible to meet this need by applying a moisture-activated adhesive strip on a web or a bobbin of roll-your-own cigarette paper by flexography, photogravure or indirect flexographic printing.

### SUMMARY

Thus, a first aspect of the invention is a process for manufacturing a bobbin of roll-your-own cigarette paper comprising a moisture-activated adhesive strip along one of its long edges, the process comprising the following steps:

a) cutting a web of roll-your-own cigarette paper in order to obtain a bobbin of roll-your-own cigarette paper,

b) applying a moisture-activated adhesive strip in order to obtain the bobbin of roll-your-own cigarette paper comprising a moisture-activated adhesive strip along one of its long edges,

the step b) of applying being carried out before or after the step a) of cutting, characterized in that the step b) of applying is carried out by flexography, photogravure or indirect flexographic printing, if necessary followed by drying.

Unlike the conventional processes using pressurized nozzles, flexography, photogravure and indirect flexographic printing, in particular flexography, are gentle methods that make it possible to greatly reduce the risk of tearing of the web of roll-your-own cigarette paper when the step b) of applying is being carried out. Thus, it is not necessary to regularly stop the process for manufacturing a bobbin of roll-your-own cigarette paper of the invention.

Furthermore, flexography makes it possible to very accurately control the sharpness of the contours of the moisture-activated adhesive strip. Thus, when the step a) of cutting is carried out after the step b) of applying, then the risks of tearing during the step a) of cutting are advantageously minimized. It is also possible to cut the bobbin more accurately and thus to optimize the cutting to minimize losses of material.

Flexography, photogravure and indirect flexographic printing, in particular flexography, also make it possible to have a run speed of the paper which may be four times higher than the speed of conventional processes.

For all these reasons, the productivity of the process for manufacturing a sheet of roll-your-own cigarette paper of the invention is greater than the productivity of conventional processes for manufacturing a sheet of roll-your-own cigarette paper.

Another aspect of the invention is a process for manufacturing a sheet of roll- your-own cigarette paper comprising a step c) of cutting a bobbin of roll-your-own cigarette paper manufactured by the process for manufacturing a bobbin of roll-your- own cigarette paper of the invention.

Another aspect of the invention is a process for manufacturing a booklet of sheets of roll-your-own cigarette paper comprising a step d2) of forming a stack of bobbins of roll-your-own cigarette paper that are manufactured by the process for manufacturing a bobbin of roll-your-own cigarette paper of the invention followed by a step e) of cutting the stack of bobbins.

The processes of the invention make it possible to advantageously produce a roll-your-own cigarette paper, in the form of a bobbin or a sheet, comprising a moisture-activated adhesive strip with a higher productivity than the productivity of conventional processes.

Furthermore, the moisture-activated strip of the paper, in the form of a bobbin or a sheet, has a grammage of less than 8-10 g/m², i.e. the grammage of the adhesive strip of a conventional sheet of roll-your-own cigarette paper.

Thus, another aspect of the invention is a roll-your-own cigarette paper, in the form of a bobbin or a sheet, comprising a moisture-activated adhesive strip, characterized in that the grammage of the moisture-activated adhesive strip is less than 8 g/m², in particular between 4 g/m² and 7.5 g/m², very particularly between 5 g/m² and 7 g/m².

Even if the adhesive strip of the roll-your-own cigarette paper of the invention has a grammage of less than 8-10 g/m², it presents unexpectedly an adhesiveness of the same order of magnitude as the adhesiveness of the adhesive strip of a conventional roll-your-own cigarette paper.

The roll-your-own cigarette paper of the invention may therefore be used to manufacture cigarettes while advantageously being less expensive to produce than a conventional paper because it requires less moisture-activated adhesive.

Another aspect of the invention is a booklet of sheets of roll-your-own cigarette paper of the invention.

Another aspect of the invention is a cigarette comprising a sheet of roll-your- own cigarette paper of the invention.

### DETAILED DESCRIPTION OF THE INVENTION

According to a first aspect, the invention is a process for manufacturing a bobbin of roll-your-own cigarette paper comprising a moisture-activated adhesive strip along one of its long edges, the process comprising the following steps:

a) cutting a web of roll-your-own cigarette paper in order to obtain a bobbin of roll-your-own cigarette paper,

b) applying a moisture-activated adhesive strip in order to obtain the bobbin of roll-your-own cigarette paper comprising a moisture-activated adhesive strip along one of its long edges,

the step b) of applying being carried out before or after the step a) of cutting, characterized in that the step b) of applying is carried out by flexography, photogravure or indirect flexographic printing, if necessary followed by drying.

Within the meaning of the present invention, the expression “roll-your-own cigarette paper” is understood to mean paper used for rolling cigarettes. It may be manufactured from wood pulp, tobacco fibers, hemp fibers, flax fibers, sisal fibers, fibers of the shell protecting the cocoa bean, cannabis fibers, rice straw, esparto fibers and mixtures thereof. The roll-your-own cigarette paper has a lower grammage and is thinner than the paper of the rolled cigarettes sold. For example, the grammage of the rolling paper, measured outside of the adhesive strip, may be between 10 g/m² and 50 g/m², in particular between 12 g/m² and 25 g/m², more particularly between 13 g/m² and 15 g/m². The thickness of the rolling paper may be between 5 micrometers and 100 micrometers, in particular between 10 micrometers and 60 micrometers, more particularly between 20 micrometers and 50 micrometers.

Within the meaning of the present invention, the expression “web of roll-your-own cigarette paper” is understood to mean a roll-your-own cigarette paper as described above, the general shape of which, once the web is unrolled, is a rectangle. Typically the length of the rectangle is several tens of meters, or even several thousands of meters, whilst its width is greater than or equal to 0.6 m, in particular greater than or equal to 1 m, more particularly greater than or equal to 1.2 m, more particularly still greater than or equal to 1.5 m.

Within the meaning of the present invention, the expression “bobbin of roll-your-own cigarette paper” is understood to mean a roll-your-own cigarette paper as described above, the general shape of which, once the bobbin is unrolled, is a rectangle and which may comprise a moisture-activated adhesive strip along one of the long edges of the rectangle. The width of the rectangle is substantially equal to the width of the sheets of roll-your-own cigarette paper, i.e. between 30 mm and 75 mm, in particular around 36 mm, around 44 mm or around 53 mm. Typically, the length of the rectangle is from several hundreds to several thousands of meters, for example between 1000 m and 15000 m, in particular between 3000 m and 10000 m, very particularly between 5000 m and 8000 m. The length of the rectangle may also be one or several tens of meters, in this case the sheet is called a roll. The length of the rectangle may also be one or more meters, in this case the sheet is referred to as a ream.

The moisture-activated adhesive strip (denoted also by adhesive strip) comprises a moisture-activated adhesive.

Within the meaning of the present invention, a “moisture-activated adhesive” is understood to mean a compound which has an adhesive property in contact with water or moisture, such as for example saliva. The moisture-activated adhesive may be any type of moisture-activated adhesive known to a person skilled in the art. For example, the moisture-activated adhesive may be chosen from sugar solutions, modified or unmodified polysaccharides, gums, and mixtures thereof, in particular gums.

As modified or unmodified polysaccharides, mention may be made of starch, alginates, dextrins, cyclodextrins or mixtures thereof.

The gums may be natural or synthetic. Examples of natural gums are acacia gum, gum arabic, guar gum, gum karaya, pectins and mixtures thereof, in particular guar gum, gum arabic and the mixture thereof, more particularly gum arabic.

The mass concentration of moisture-activated adhesive in the adhesive strip of the bobbin of roll-your-own cigarette paper, without taking into account the roll-your-own cigarette paper, may for example be at least 95%, in particular at least 97%, more particularly at least 99%, more particularly still 100%.

The adhesive strip may also comprise an additive for imparting a property other than adhesiveness to the adhesive strip.

For example, the additive may be a plasticizer, an antifoam, a dye, an aromatic compound, or mixtures thereof, in particular a plasticizer, an antifoam or the mixture thereof.

Sorbitol is an example of a plasticizer which may be used within the context of the present invention.

As dye, mention may be made of natural or artificial food colorings, in particular natural food colorings. Caramels, chlorophyllin, the coloring derived from paprika, the coloring derived from beetroot, carotene, the coloring derived from turmeric, cochineal, the coloring derived from annatto seeds, lutein, the coloring derived from sunflowers, anthocyanins, the coloring derived from malt, charcoal and thermoluminescent pigments are examples of natural food colorings.

The aromatic compound may be chosen from glycosylated modified flavors, encapsulated flavors (cyclodextrins, membranes or matrices), natural flavors and mixtures thereof. The aromatic compound may in particular be chosen from EVG, Emanates, synthetic or natural cannabidiol (CBD), synthetic or natural tetrahydrocannabinol (THC), terpenes and mixtures thereof.

Typically, the grammage of the adhesive strip, excluding the roll-your-own cigarette paper, is less than 8 g/m², in particular between 5.5 g/m² and 7.5 g/m², more particularly between 5 g/m² and 6.5 g/m².

The grammage of the adhesive strip is determined by weighing the mass of 1 m² of a zone of the bobbin of paper without adhesive strip, by weighing the mass of 1 m² of a zone of the bobbin of paper comprising the adhesive strip and by subtracting the two masses.

These grammage values may be achieved by flexography, photogravure or indirect flexographic printing, in particular by flexography.

The bobbin manufactured by the process of the invention is therefore less expensive than a bobbin manufactured by a process from the prior art since it requires smaller amounts of moisture-activated adhesive.

Furthermore, unexpectedly, the inventors have observed that the adhesive strip of the bobbin manufactured by the process of the invention has an adhesiveness of the same order of magnitude as the adhesiveness of the adhesive strips of bobbins manufactured by the processes of the prior art.

Typically, the width of the adhesive strip is between 1 mm and 10 mm, in particular between 4 mm and 8 mm, more particularly between 5 mm and 7 mm.

The adhesive strip may have a continuous or discontinuous shape.

As a continuous shape, mention may be made of a straight line, a zigzag pattern, a crenellated pattern or a wave pattern.

Examples of a discontinuous shape are a discontinuous line of geometric shapes, logos or a mixture thereof. The line may be straight or curved.

Examples of a geometric shape are a polygon, a circle, an ellipse, an oval and mixtures thereof. The polygon may be a triangle, a quadrilateral such as a square, a rectangle, or a lozenge, a pentagon, a hexagon or an octagon.

The logo may be a logo of a manufacturer of roll-your-own cigarette paper.

Step a) of cutting the web of roll-your-own cigarette paper is a conventional step known to person skilled in the art. The step a) of cutting makes it possible to obtain one or more bobbins, for example from 2 to 100 bobbins, in particular from 30 to 55 bobbins.

The step a) of cutting may, for example, be carried out at a run speed of the paper of greater than or equal to 100 m/min, in particular greater than or equal to 500 m/min, more particularly greater than or equal to 750 m/min, more particularly still greater than or equal to 1000 m/min.

According to one embodiment, the step b) of applying is carried out after the step a) of cutting. In this case, step b) of applying is carried out on at least one bobbin of roll-your-own cigarette paper resulting from step a).

According to an alternative embodiment, the step b) of applying is carried out before the step a) of cutting. In this case, step b) is carried out on the web of roll-your-own cigarette paper in order to obtain an adhesive web of paper, then the adhesive web of paper is cut during step a) to obtain the bobbin.

According to this alternative embodiment, it is possible to apply several adhesive strips to one web of roll-your-own cigarette paper then to cut the adhesive web of paper to obtain several bobbins of paper.

Thus, one particular embodiment of the invention is a process for manufacturing n bobbins of roll-your-own cigarette paper, each bobbin of roll-your-own cigarette paper comprising an adhesive strip along one of its long edges, the process comprising the following steps:

b) applying n adhesive strips to a web of roll-your-own cigarette paper in order to obtain an adhesive web of paper, each of the n adhesive strips extending in the machine direction, and

a) cutting the adhesive web of paper in the machine direction along n−1 adhesive strips to obtain that the n bobbins of roll-your-own cigarette paper, n being an integer greater than or equal to 2,

characterized in that the step b) of applying is carried out by flexography, photogravure or indirect flexographic printing, if necessary followed by drying.

This process is particularly efficient since it is more efficient to apply n adhesive strips to a web of roll-your-own cigarette paper then to cut said web of roll-your-own cigarette paper into n bobbins of roll-your-own cigarette paper than to cut one web of roll-your-own cigarette paper into n bobbins of roll-your-own cigarette paper and to apply a single strip to each of the n bobbins of roll-your-own cigarette paper.

According to one embodiment, n is an integer below 100, in particular between 30 and 55.

The step b) of applying may, for example, be carried out at a run speed of the paper of greater than or equal to 70 m/min, in particular greater than or equal to 100 m/min, more particularly greater than or equal to 150 m/min, more particularly still greater than or equal to 200 m/min.

According to one particular embodiment, the step b) of applying is carried out by flexography, followed if necessary by drying.

Flexography is a relief printing process known by a person skilled in the art in which a flexible relief plate, referred to as a plate, is impregnated with a printing solution, the substrate and the impregnated plate are brought into contact so that the printing solution is applied on the substrate.

Within the context of the present invention, flexography advantageously enables the contact of a plate impregnated with a solution of moisture-activated adhesive and of the web of roll-your-own cigarette paper in order to enable the application of n adhesive strips on the web of roll-your-own cigarette paper.

Flexography also makes it possible to have a run speed of the paper which may be four times higher than the speed of conventional processes. Thus, the productivity of the process for manufacturing a bobbin of roll-your-own cigarette paper of the invention is therefore greater than conventional processes.

One of the advantages of flexography is the very precise control of the sharpness of the contours of the adhesive strip. Thus, the risks of tearing during step a) of cutting the adhesive web of paper to manufacture a roll-your-own cigarette bobbin comprising an adhesive strip along one of its long edges are advantageously minimized. It is also possible to cut the web more precisely and thus optimize the cutting in order to minimize losses of material. Consequently, the productivity of the process for manufacturing a bobbin of roll-your-own cigarette paper of the invention using the step b) of applying carried out by flexography is greater than the productivity of conventional processes.

Among the other advantages offered by flexography, mention may be made of the simplicity and low production cost of the plates.

Moreover, flexography is a flexible method which makes it possible to obtain an adhesive strip, the shape of which depends on the shape of the plate.

Furthermore, the tensile strength in the machine direction and in the cross direction of the bobbins manufactured after an application step a) performed by a flexographic printer is greater than that of the bobbins manufactured by a conventional process. The bobbins manufactured after an application step a) performed by a flexographic printer may therefore easily be used in steps subsequent to the process for manufacturing bobbins of the invention, such as for example a step of cutting the bobbin into sheets or a step of forming a stack of bobbins followed by a step of cutting the stack into a stack of sheets.

Flexography, photogravure and indirect flexographic printing may use an adhesive solution.

The moisture-activated adhesive solution (also referred to as adhesive solution) comprises a moisture-activated adhesive. The mass concentration of moisture-activated adhesive in the adhesive solution may be between 30% and 60%, in particular between 32% and 45%, more particularly between 35% and 40%.

The adhesive solution is typically an aqueous solution. The moisture-activated adhesive solution may also comprise an additive as described above.

According to one particular embodiment, the adhesive solution may comprise a moisture-activated adhesive, a plasticizer, and an antifoam, and the mass concentration of moisture-activated adhesive is from 30% to 50%, the mass concentration of plasticizer is from 0.1% to 0.5% and the mass concentration of antifoam is from 0.5% to 1%.

The optional drying step is a conventional drying step known by a person skilled in the art. The latter will therefore know how to adapt it to the process for manufacturing a bobbin of roll-your-own cigarette paper of the invention.

As explained above, the adhesiveness of the adhesive strip of the bobbin manufactured by the process of the invention is of the same order of magnitude as the adhesiveness of the adhesive strips of the bobbins manufactured by processes from the prior art. A bobbin manufactured by the process of the invention can therefore be cut into a sheet of roll-your-own cigarette paper which will then be used to form a roll-your-own cigarette.

Another aspect of the invention is therefore a process for manufacturing a sheet of roll-your-own cigarette paper comprising a step c) of cutting a bobbin of roll-your-own cigarette paper manufactured by the process for manufacturing a bobbin of roll-your-own cigarette paper of the invention in order to manufacture a sheet of roll-your-own cigarette paper.

Within the meaning of the invention, the expression “sheet of roll-your-own cigarette paper” is understood to mean a roll-your-own cigarette paper as described above, the general shape of which is a rectangle and which comprises an adhesive strip as described above along one of the long edges of the rectangle. Typically, the length of the rectangle is between 70 mm and 110 mm whilst its width may vary from 30 mm to 75 mm.

Step c) of cutting the bobbin of roll-your-own cigarette paper is a conventional cutting step known by a person skilled in the art. The latter will therefore know how to adapt it to the process for manufacturing a sheet of roll-your-own cigarette paper of the invention.

The sheet of roll-your-own cigarette paper manufactured by the process of the invention is conventionally sold in the form of a booklet.

The invention therefore also relates to a process for manufacturing a booklet of sheets of roll-your-own cigarette paper comprising a step d1) of forming a stack of sheets of roll-your-own cigarette paper manufactured by the process for manufacturing a sheet of roll-your-own cigarette paper of the invention.

The step d1) of forming may for example be carried out by stacking the sheets of roll-your-own cigarette paper one on top of the other or by inserting one sheet of roll-your-own cigarette paper between 2 sheets of roll-your-own cigarette paper.

For example, the step d1) of forming may be carried out by inserting the sheets using equipment sold by IMAtec in Luxembourg.

According to one embodiment, the stack of sheets formed after step d1) may undergo an entangling step in order to form a stack of entangled sheets.

The stack of sheets, entangled or not, may then be introduced into a case.

The invention therefore also relates to a process for manufacturing a booklet of sheets of roll-your-own cigarette paper comprising a step d2) of forming a stack of bobbins of roll-your-own cigarette paper manufactured by the process for manufacturing a bobbin of roll-your-own cigarette paper of the invention followed by a step e) of cutting the stack of bobbins.

The stack of bobbins may be formed during step d2) by unrolling the bobbins of roll-your-own cigarette paper and stacking the unrolled bobbins of roll-your-own cigarette paper one on top of the other or by inserting one unrolled bobbin of roll-your-own cigarette paper between two unrolled bobbins of roll-your-own cigarette paper.

According to one embodiment, the stack of sheets formed in step e) of cutting the stack of bobbins may undergo an entangling step in order to form a stack of entangled sheets.

According to one embodiment, the stack of bobbins formed in step d2) may undergo an entangling step before the cutting step in order to form a stack of entangled sheets.

The stack of sheets, entangled or not, may then be introduced into a case.

As explained above, the roll-your-own cigarette paper, in bobbin or sheet form, comprises an adhesive strip, the grammage of which is advantageously less than the conventional grammage of 8-9 g/m2.

Thus, the invention also relates to a roll-your-own cigarette paper, in bobbin or sheet form, comprising an adhesive strip as described above in connection with the process for manufacturing a bobbin of roll-your-own cigarette paper of the invention.

Advantageously, the roll-your-own cigarette paper of the invention is less expensive than a roll-your-own cigarette paper manufactured by a process from the prior art since it requires less moisture-activated adhesive.

Furthermore, and unexpectedly, the inventors have observed that the adhesive strip of the roll-your-own cigarette paper of the invention has an adhesiveness of the same order of magnitude as the adhesiveness of the adhesive strips of the roll-your-own cigarette papers manufactured by the processes of the prior art.

The roll-your-own cigarette paper and the adhesive strip of the roll-your-own cigarette paper are as described above in connection with the process for manufacturing a bobbin of roll-your-own cigarette paper of the invention.

According to one embodiment, the roll-your-own cigarette paper in bobbin form is capable of being obtained by the process for manufacturing a bobbin of roll-your-own cigarette paper described above.

According to one embodiment, the roll-your-own cigarette paper in sheet form is capable of being obtained by the process for manufacturing a sheet of roll-your-own cigarette paper described above.

The roll-your-own cigarette paper in sheet form may be sold as a booklet.

The invention therefore also relates to a booklet of papers for roll-your-own cigarettes in sheet form as described above. This booklet is capable of being obtained by the process for manufacturing a booklet of sheets of roll-your-own cigarette paper described above.

The roll-your-own cigarette paper in sheet form may for example be used to form a cigarette. The invention therefore also relates to a cigarette comprising the roll-your-own cigarette paper in sheet form.

### EXAMPLES

### Example 1 According to the Invention

An aqueous solution of gum arabic (gum arabic content of 38% by weight) is applied by flexography with four plates to a web of roll-your-own cigarette paper advancing at a speed of 220 m/min. The web is then dried and then cut to obtain 4 bobbins, each bobbin comprising an adhesive strip comprising gum arabic, the gram mage of which is 6 g/m².

The bobbin is then cut into sheets.

Each sheet has a rectangular shape with a length of 110 mm, a width of 44 mm and a continuous adhesive strip along one of the two long edges of the sheet and the grammage of which is 6 g/m².

### Comparative Example 2

A web of roll-your-own cigarette paper is cut into bobbins. An aqueous solution of gum arabic (gum arabic content of 45% by weight) is applied by a nozzle to a bobbin of roll-your-own cigarette paper advancing at a speed of 55 m/min. The bobbin is then dried in order to obtain a bobbin with an adhesive strip comprising gum arabic, the grammage of which is 8 g/m².

The bobbin is then cut into sheets.

Each sheet has a rectangular shape with a length of 110 mm, a width of 44 mm and a continuous adhesive strip along one of the two long edges of the sheet and the grammage of which is 8 g/m²

Comparison of the process of Example 1 (according to the invention) and of the process of Example 2 (comparative)

The process for manufacturing the sheet of Example 1 (according to the invention) is 4 times faster than the process for manufacturing the sheet of Example 2 (comparative), requires less gum arabic and makes it possible to manufacture a sheet comprising a continuous adhesive strip, the grammage of which is 6 g/m², as opposed to 8 g/m², i.e. a reduction of 15%.

The productivity of the process of Example 1 is therefore greater than the productivity of the process of Example 2.

### Example 3—Test of Adhesiveness

10 sheets according to the invention (manufactured by the process of Example 1) are glued together after moistening of the adhesive strip. After natural drying, the ungluing of the sheets is tested by pulling on the sheets. 8 sheets out of 10 do not unglue.

10 comparative sheets (manufactured by the process of Example 2) are glued together after moistening of the adhesive strip. After natural drying, the un-gluing of the sheets is tested by pulling on the sheets. 9 sheets out of 10 do not unglue.

This test highlights that the sheets according to the invention, the adhesive strip of which comprises 15% less gum arabic than the adhesive strip of the comparative sheets, has an adhesiveness of the same order of magnitude as the comparative sheets.

1. Process for manufacturing a bobbin of roll-your-own cigarette paper comprising a moisture-activated adhesive strip along one of its long edges, the process comprising the following steps:
a) cutting a web of roll-your-own cigarette paper in order to obtain a bobbin of roll-your-own cigarette paper,
b) applying a moisture-activated adhesive strip in order to obtain the bobbin of roll-your-own cigarette paper comprising a moisture-activated adhesive strip along one of its long edges,
the step b) of applying being carried out before or after the step a) of cutting, characterized in that the step b) of applying is carried out by flexography, photogravure or indirect flexographic printing.

2. Process according to claim 1, wherein the moisture-activated adhesive is chosen from sugar solutions, polysaccharides, starch and gums and mixtures thereof.

3. Process according to claim 1, wherein the grammage of moisture-activated adhesive strip is less than 8 g/m².

4. Process according to claim 1, wherein the mass concentration of moisture-activated adhesive in the moisture-activated adhesive strip is at least 95%.

5. Process according to claim 1, wherein the moisture-activated adhesive strip comprises an additive chosen from a plasticizer, an antifoam, a dye, an aromatic compound and mixtures thereof.

6. Process for manufacturing a sheet of roll-your-own cigarette paper comprising a step c) of cutting at least one bobbin of roll-your-own cigarette paper manufactured by the process as defined in claim 1 in order to manufacture a sheet of roll-your-own cigarette paper.

7. Process for manufacturing a booklet of sheets of roll-your-own cigarette paper comprising a step d1) of forming a stack of sheets of roll-your-own cigarette paper that are manufactured by the process as defined in claim 6.

8. Process for manufacturing a booklet of sheets of roll-your-own cigarette paper comprising a step d2) of forming a stack of bobbins of roll-your-own cigarette paper that are manufactured by the process as defined in claim 1 followed by a step e) of cutting the stack of bobbins to form a stack of sheets.

9. Roll-your-own cigarette paper, in the form of a bobbin or a sheet, comprising a moisture-activated adhesive strip, characterized in that the grammage of the moisture-activated adhesive strip is less than 8 g/m²

10. Roll-your-own cigarette paper according to claim 9, wherein the moisture-activated adhesive of the moisture-activated adhesive strip is chosen from sugar solutions, polysaccharides, starch and gums, and mixtures thereof.

11. Roll-your-own cigarette paper according to claim 10, wherein the mass concentration of moisture-activated adhesive in the moisture-activated adhesive strip is at least 95.

12. Roll-your-own cigarette paper according to claim 10, wherein the moisture-activated adhesive strip comprises an additive chosen from a plasticizer, an antifoam, a dye, an aromatic compound and mixtures thereof.

13. Booklet of papers for roll-your-own cigarettes in sheet form as defined according to claim 10.

14. Cigarette comprising the roll-your-own cigarette paper in sheet form as defined according to claim 10.
